(19) United States
(12) Patent Application Publication
(10) Pub. No.: US 2015/0346634 A1
(43) Pub. Date: Dec. 3, 2015

(54) TONER CARTRIDGE AND IMAGE FORMING APPARATUS

(71) Applicant: Sharp Kabushiki Kaisha, Osaka (JP)

(72) Inventor: Toshihide OHGOSHI, Osaka-shi (JP)

(21) Appl. No.: 14/701,849

(22) Filed: May 1, 2015

(30) Foreign Application Priority Data
May 27, 2014 (JP) 2014-108644

(51) Int. Cl. G03G 15/08

(52) U.S. Cl. CPC G03G 15/0865

(57) ABSTRACT

A toner cartridge includes a cylindrical casing configured so as to be rotatable, a discharge port discharging toner inside the casing to a storage section of a developing unit, and a plurality of slanted ribs on an inner circumferential surface of the casing with one or more discontinuous sections formed in between. The plurality of slanted ribs each include a first slanted rib located on a downstream side of the discontinuous section and a second slanted rib located on an upstream side of the discontinuous section with respect to a toner flow direction. A first end portion formed on the discontinuous section of the first slanted rib is disposed at a position relatively shifted by a predetermined length toward a toner inputting side in relation to a position on an extension line of a second end portion formed on the discontinuous section of the second slanted rib.

### CROSS REFERENCE

This Nonprovisional application claims priority under 35 U.S.C. §119(a) on Patent Application No. 2014-108644 filed in Japan on May 27, 2014, the entire contents of which are hereby incorporated by reference.

### BACKGROUND OF THE INVENTION

1. Technical Field

The present invention relates to a toner cartridge for containing toner to be replenished to a developing unit, and to an image forming apparatus.

2. Background Art

An image forming apparatus forms an image onto a paper sheet through forming a toner image with toner that is supplied from a developing unit to a photoreceptor on which an electrostatic latent image has been formed, transferring the toner image onto the paper sheet either directly or indirectly, and fixing the toner image on the paper sheet. The developing unit is configured so that thereto a toner cartridge for replenishing the toner is removably attached, because it becomes impossible for the developing unit to supply the toner to the photoreceptor when the toner that is stored in a storage section of its own decreases. The developing unit periodically replenishes the toner from the toner cartridge to the storage section.

Among the toner cartridges is one that is provided with a cylindrical casing, a spiral rib protruding from an inner circumferential surface of the cylindrical casing, and a discharge port for discharging the toner, and transports, with the spiral rib, the toner to the discharge port while the casing is rotated. If the spiral rib is formed over an entire range of the inner circumferential surface, a strength of the casing decreases. In this regard, among the prior art cartridges is one that is provided with a plurality of slanted ribs with one or more discontinuous sections being formed in between, as described in the Japanese Patent Unexamined Publication No. 2007-102135 bulletin.

However, with the plurality of slanted ribs, when the toner is flown from a second slanted rib located on an upstream side of the discontinuous section to a first slanted rib located on a downstream side of the discontinuous section with respect to a toner flow direction, part of the toner flows toward an opposite side of the second slanted rib in relation to the discharge port and thus cannot flow toward the second slanted rib. Accordingly, a service life of the toner cartridge ends with part of the toner being unable to be transported to the discharge port but remaining unmoved inside the casing.

The present invention is directed to providing a toner cartridge capable of reducing toner that remains unmoved inside a casing, and an image forming apparatus.

### SUMMARY OF THE INVENTION

A toner cartridge of the present invention includes a cylindrical casing and a plurality of slanted ribs, is configured so as to be removably attached to a developing unit, and replenishes toner to the developing unit. The cylindrical casing is configured so as to be rotatable, and is provided with a discharge port for discharging the toner that is received from a toner inputting side. The plurality of slanted ribs are provided on an inner circumferential surface of the casing for transporting the toner, and one or more discontinuous sections are formed in between. Each of the plurality of slanted ribs includes a first slanted rib located on a downstream side of the discontinuous section, and a second slanted rib located on an upstream side of the discontinuous section, with respective to a toner flow direction. A first end portion formed on the discontinuous section's side of the first slanted rib is disposed at a position relatively shifted toward the toner inputting side in relation to a second end portion formed on the discontinuous section's side of the second slanted rib.

### BRIEF DESCRIPTION OF THE DRAWINGS

FIG. 1 is a schematic drawing showing a main part of an image forming apparatus according to a first embodiment of the present invention.

FIG. 2A is a cross-sectional view of a toner cartridge configured so as to be removably attached to the image forming apparatus, with FIG. 2B being a partially enlarged cross-sectional view of the toner cartridge.

FIG. 3 is a partially enlarged cross-sectional view of a toner cartridge according to a second embodiment of the present invention.

FIG. 4 is a partially enlarged cross-sectional view of a toner cartridge according to a third embodiment of the present invention.

FIG. 5 is a partially enlarged cross-sectional view of a toner cartridge according to a fourth embodiment of the present invention.

FIG. 6 is a partially enlarged cross-sectional view of a toner cartridge according to a fifth embodiment of the present invention.

FIG. 7 is a partially enlarged cross-sectional view of a toner cartridge according to a sixth embodiment of the present invention.

### DETAILED DESCRIPTION OF THE INVENTION

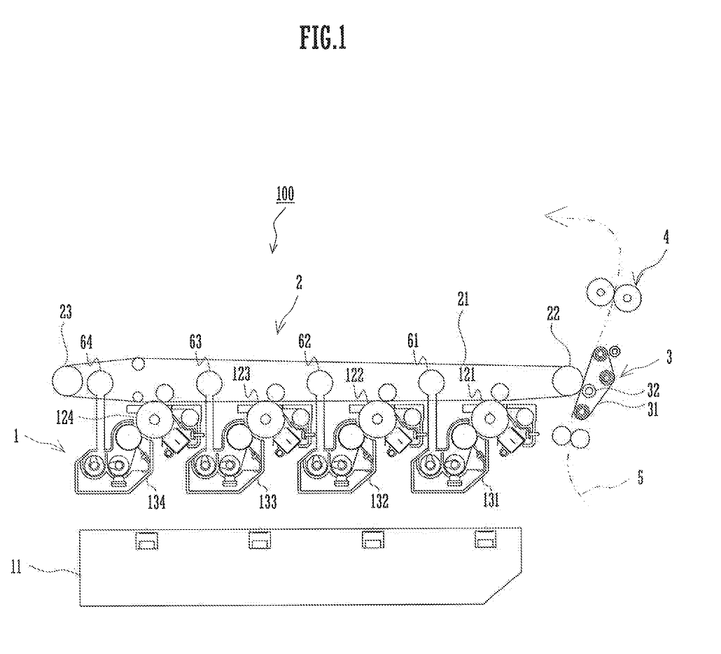

An image forming apparatus that is configured so that thereto a toner cartridge according to a first embodiment of the present invention is removably attached is explained, referring to the drawings. As shown in FIG. 1, an image forming apparatus 100 performs, for example, a multi-colored or monochromatic image forming process onto a paper sheet according to the electrophotography method based on image data inputted from an external device not illustrated. The image forming apparatus 100 includes an image forming unit 1, an intermediate transfer unit 2, a secondary transfer unit 3, a fixing section 4 and a paper sheet conveying path 5.

The image forming unit 1 causes surfaces of photoreceptor drums 121-124 to be charged with electricity uniformly at a predetermined electrostatic potential, forms electrostatic latent images on the surfaces of the photoreceptor drums 121-124 by irradiating thereof with image lights from an exposure unit 11 based on the image data, supplies the electrostatic latent images with toners from developing units 131-134, and forms thereby toner images. The developing units 131-134 are respectively configured so that thereto toner cartridges 61-64 are removably attached, and replenish the toners from the toner cartridges 61-64 when the toners stored in storing sections run short.

The intermediate transfer unit 2 has an intermediate transfer belt 21, a drive roller 22 and an idle roller 23. The intermediate transfer belt 21 is passed over the drive roller 22 and the idle roller 23, and moves along a circulating path that passes through the photoreceptor drums 124, 123, 122, and 121 in this order. In consequence of the movement, the toner images that have been formed on the surfaces of the photoreceptor drums 121-124 undergo primary transfers onto a surface of the intermediate transfer belt 21.

The secondary transfer unit 3 has a secondary transfer belt 31 and a secondary transfer roller 32. The secondary transfer belt 31 is passed over a plurality of rollers, and moves along a predetermined circulating path. The secondary transfer roller 32 is disposed in such a manner as to face the drive roller 22 sandwiching the intermediate transfer belt 21 and the secondary transfer belt 31 in between. The secondary transfer unit 3 performs a secondary transfer of a toner image on the surface of the intermediate transfer belt 21 onto a paper sheet that is conveyed to a secondary transfer position between the intermediate transfer belt 21 and the secondary transfer belt 31.

The fixing section 4 heats and presses the paper sheet onto which the toner image has been transferred, and fixes thereby the toner image that has been transferred onto the paper sheet durably on the surface of the paper sheet.

The paper sheet conveying path 5 is formed in a range from a paper feeding cassette not illustrated to a paper receiving tray not illustrated via the secondary transfer position and the fixing section 4.

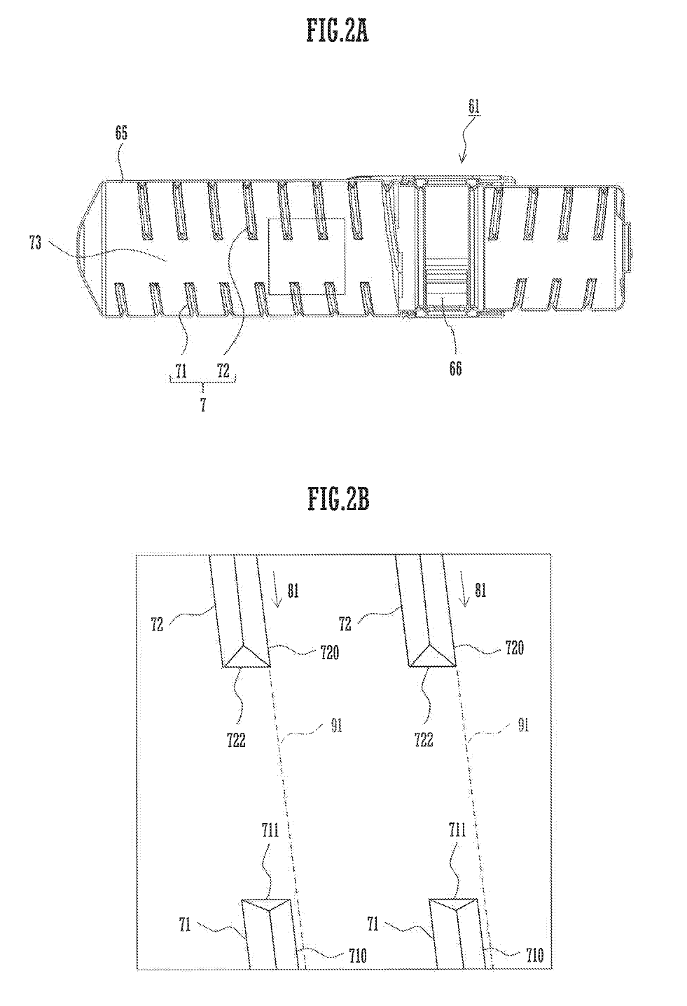

As shown in FIG. 2A, the toner cartridge 61 is provided with a casing 65, a discharge port 66 and a plurality of slanted ribs 7. Here, the toner cartridges 62-64 have the same configurations as the toner cartridge 61.

The casing 65 has a cylindrical shape, and is configured so as to be rotatable. The discharge port 66 is formed at a predetermined position of the casing 65 in a direction of a rotational axis thereof. The discharge port 66 is connected to a storage section of the developing unit 131 in a state where the toner cartridge 61 is mounted on the developing unit 131. The discharge port 66 has a door (not illustrated) that can be opened and closed, and discharges the toner inside the casing 65 to the storage section of the developing unit 131 in a state where the door is opened.

That is to say, the rotation of the casing 65 causes the toner inside the casing 65 to be conveyed from each of both end portions of the casing 65 toward the discharge port 66 along the direction of the rotational axis. Directions of conveyance of the toner along the direction of the rotational axis correspond to directions of moving from each of the both end portions of the casing 65 toward the discharge port 66. Hereinafter, an upstream side in a direction of conveyance along the direction of the rotational axis is referred to as the toner inputting side, and a downstream side in the direction of conveyance along the direction of the rotational axis is referred to as the discharge port 66's side.

On an inner circumferential surface of the casing 65, a plurality of slanted ribs 7 are provided, with one or more discontinuous sections 73 being formed in between. The plurality of slanted ribs 7 are provided for transporting the toner, and are formed parallelly from each of the both end portions toward the discharge port 66 with respect to the direction of the rotational axis of the casing 65. The discontinuous sections 73 are formed from one end to the other end with respect to the direction of the rotational axis of the casing 65. Here, the discontinuous section 73 is only required to have a predetermined length, and one or more thereof may be formed. The one or more discontinuous sections 73 ensure the strength of the casing 65. Moreover, the slanted ribs 7 may be either of linear shape or of curved shape.

Further, as shown in FIG. 2B, the plurality of slanted ribs 7 each include a first slanted rib 71 located on a downstream side of the discontinuous section 73 and a second slanted rib 72 located on an upstream side of the discontinuous section 73 with respect to a toner flow direction 81 which is a direction toward which the toner flows along the slanted ribs. A first end portion 711 formed on the discontinuous section 73's side of the first slanted rib 71 is disposed at a position relatively shifted toward the toner inputting side in relation to a position on an extension line 91 of the second slanted rib 72. Also, a discharge port 66's side of the first end portion 711 is disposed at a position relatively shifted toward the toner inputting side in relation to a position on an extension line 91 of a side 720 on the discharge port 66's side of the second slanted rib 72.

Moreover, the first end portions 711 may respectively be disposed in such a manner as to be shifted toward the toner inputting side at equal intervals, or be disposed at positions shifted the more toward the toner inputting side, the closer to the discharge port 66. Or, the first end portions 711 may respectively be disposed at positions shifted the less toward the toner inputting side, the closer to the discharge port 66. Additionally, the first end portion 711 is only required to be disposed at a position shifted by a length to a degree in which the toner dropped from the first end portion 711 of the first slanted rib 71 is unlikely to flow toward the toner inputting side of the second slanted rib 72.

Here, the plurality of slanted ribs 7 cause the toner to flow along the toner flow direction 81 through the rotation of the casing 65. The toner inside the casing 65 is caused to flow along the side 720 on the discharge port 66's side of the second slanted rib 72, and on arriving at a second end portion 722 that is formed on the discontinuous section 73's side of the second slanted rib 72, drops immediately along the extension line 91 of the side 720 on the discharge port 66's side of the second slanted rib 72. The toner dropped is more likely to flow toward the discharge port 66's side of the first slanted rib 71 than the toner inputting side of the first slanted rib 71. The toner having flown toward the discharge port 66's side of the first slanted rib 71 is caused to flow along a side 710 on the discharge port 66's side of the first slanted rib 71.

From the above, since, with the second slanted rib 72, most of the toner drops along the extension line 91 of the side 720 on the discharge port 66's side of its own, it is possible to flow most of the toner to the side 710 on the discharge port 66's side of the first slanted rib 71. As a result, the toner cartridge 61 can cause most of the toner to flow from the toner inputting side to the discharge port 66 through the rotation of the casing 65, and can thereby discharge most of the toner from the discharge port 66. Accordingly, the toner cartridge 61 can reduce the toner that remains unmoved inside the casing 65, thereby extending its service life. Also, thanks to the extended service life of the toner cartridge 61, the image forming apparatus 100 can reduce the number of replacement of the toner cartridge 61, thereby being able to increase its operating ratio.

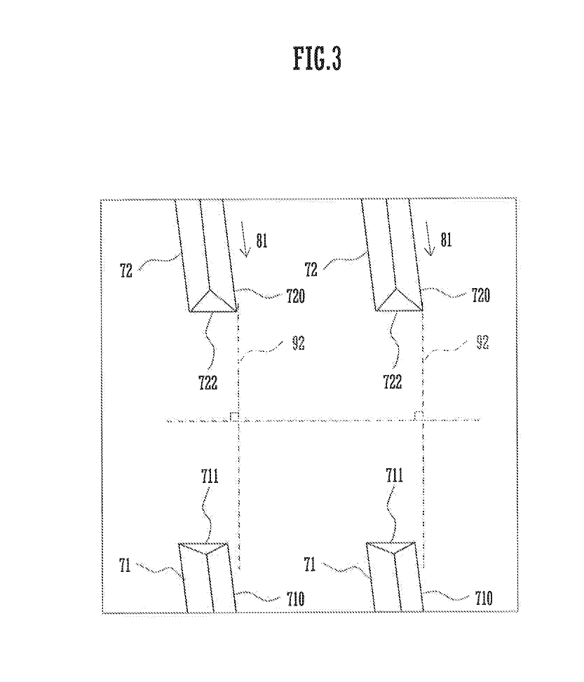

A toner cartridge according to a second embodiment is different from the toner cartridge according to the first embodiment in the following respects. As shown in FIG. 3, the first end portion 711 of the first slanted rib 71 is disposed at a position relatively shifted toward the toner inputting side in relation to a position of the second end portion 722 of the second slanted rib 72 in terms of a projection perpendicular 92 to the rotational axis of the casing 65. Moreover, the discharge port 66's side of the first end portion 711 is disposed at a position relatively shifted toward the toner inputting side in relation to a position of the discharge port 66's side of the second end portion 722 in terms of a projection perpendicular 92 to the rotational axis of the casing 65.

From the above, with the second slanted rib 72, even when the toner that is caused to flow along the side 720 on the discharge port 66's side of its own drops perpendicularly from the second end portion 722, it is possible to flow most of the toner to the side 710 on the discharge port 66's side of the first slanted rib 71.

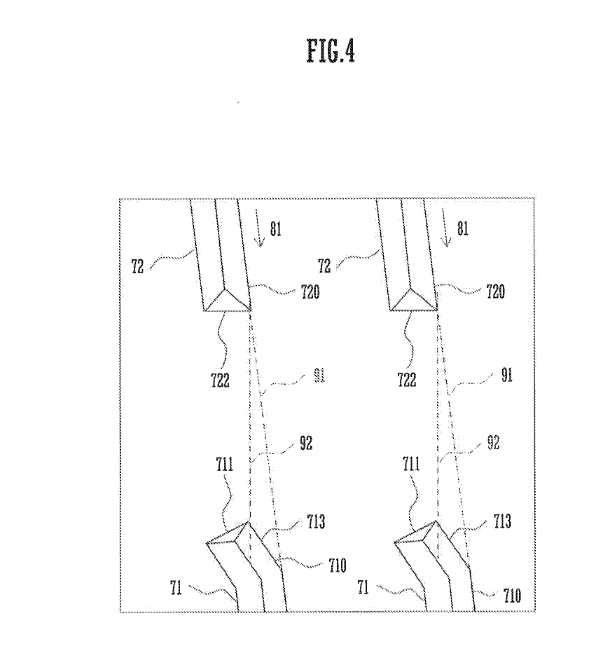

A toner cartridge according to a third embodiment is different from the toner cartridges according to the first and the second embodiments in the following respects. As shown in FIG. 4, the toner cartridge 61 has a bent portion 713 that is bent toward the toner inputting side on the first end portion 711's side of the first slanted rib 71. Also, the bent portion 713 may include a curved portion that is curved toward the toner inputting side.

Moreover, the discharge port 66's side of the bent portion 713 is disposed at a position relatively shifted toward the toner inputting side in relation to the position on the extension line 91 of the side 720 on the discharge port 66's side of the second slanted rib 72 and the position on the discharge port 66's side of the second end portion 722 in terms of a projection perpendicular 92 to the rotational axis of the casing 65.

From the above, since, with the second slanted rib 72, the toner that is caused to flow along the side 720 on the discharge port 66's side of the second slanted rib 72 can be received by the bent portion 713, it is possible to flow most of the toner to the side 710 on the discharge port 66's side of the first slanted rib 71.

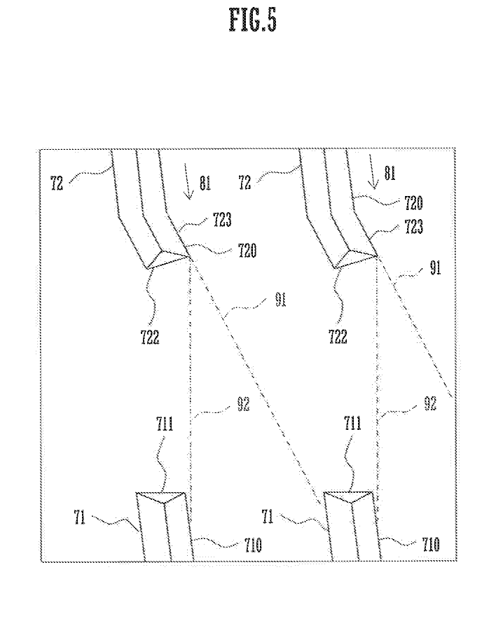

A toner cartridge according to a fourth embodiment is different from the toner cartridge according to the third embodiment in the following respects. As shown in FIG. 5, instead of the bent portion 713, the toner cartridge 61 may have a bent portion 723 that is bent toward the discharge port 66's side on the second end portion 722's side of the second slanted rib 72. Also, the bent portion 723 may include a curved portion that is curved toward the discharge port 66's side.

Moreover, the discharge port 66's side of the first end portion 711 is disposed at a position relatively shifted toward the toner inputting side in relation to the position on the extension line 91 of the side 720 on the discharge port 66's side of the bent portion 723 and the position on the discharge port 66's side of the second end portion 722 in terms of a projection perpendicular 92 to the rotational axis of the casing 65.

From the above, since, with the second slanted rib 72, the toner that is caused to flow along the side 720 on the discharge port 66's side of its own is caused to drop toward the discharge port 66's side by the bent portion 723, it is possible to flow most of the toner to the side 710 on the discharge port 66's side of the first slanted rib 71.

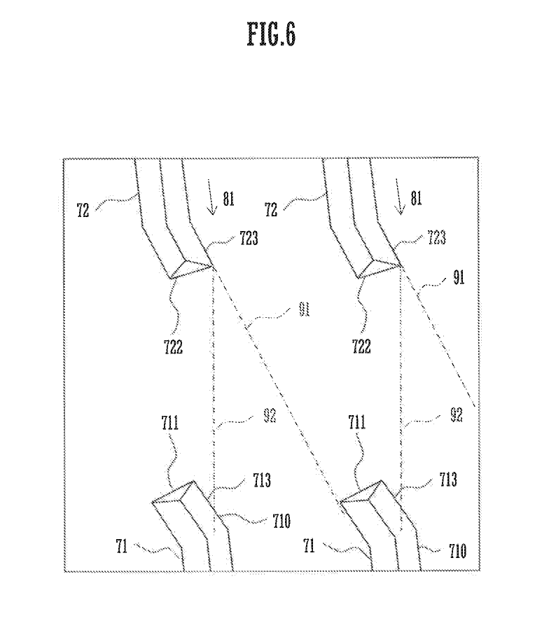

A toner cartridge according to a fifth embodiment is different from the toner cartridges according to the third and the fourth embodiments in the following respects. As shown in FIG. 6, the toner cartridge 61 may have a bent portion 713 that is bent toward the toner inputting side on the first end portion 711's side of the first slanted rib 71, and a bent portion 723 that is bent toward the discharge port 66's side on the second end portion 722's side of the second slanted rib 72. Also, the bent portion 713 may include a curved portion that is curved toward the toner inputting side; and the bent portion 723 may include a curved portion that is curved toward the discharge port 66's side.

Moreover, the discharge port 66's side of the bent portion 713 is disposed at a position relatively shifted toward the toner inputting side in relation to the position on the extension line 91 of the side 720 on the discharge port 66's side of the bent portion 723 and the position on the discharge port 66's side of the second end portion 722 in terms of a projection perpendicular 92 to the rotational axis of the casing 65.

From the above, since, with the second slanted rib 72, not only can the toner that is caused to flow along the side 720 on the discharge port 66's side of its own be caused to drop toward the discharge port 66's side by the bent portion 723, but also the toner that is caused to flow along the side 720 on the discharge port 66's side of the bent portion 723 can be received by the bent portion 713, it is possible to flow most of the toner to the side 710 on the discharge port 66's side of the first slanted rib 71.

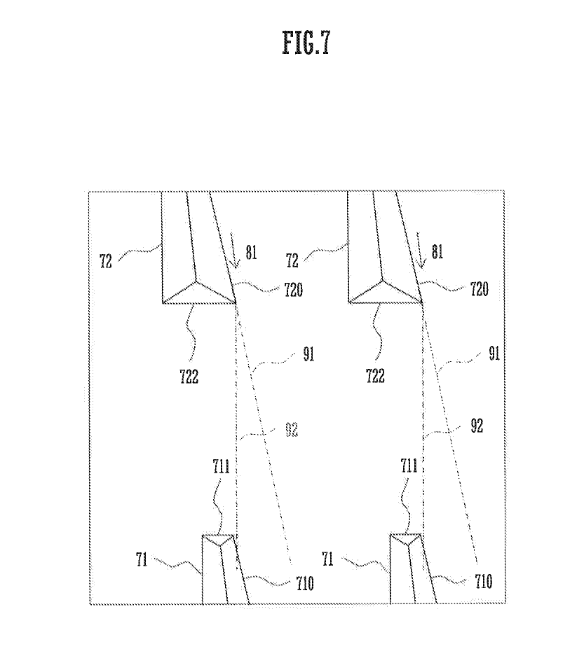

A toner cartridge according to a sixth embodiment is different from the toner cartridges according to the first and the second embodiments in the following respects. As shown in FIG. 7, the toner cartridge 61 has a first slanted rib 71 and a second slanted rib 72 of which widths become wider along the toner flow direction 81. Accordingly, it follows that the first end portion 711 of the first slanted rib 71 has a narrower width of rib than that of the second end portion 722 of the second slanted rib 72. That is to say, the second end portion 722 of the second slanted rib 72 is located more on the discharge port 66's side than the first end portion 711 of the first slanted rib 71. Moreover, the discharge port 66's side of the first end portion 711 is disposed at a position relatively shifted toward the toner inputting side in relation to the position on the extension line 91 of the side 720 on the discharge port 66's side of the second slanted rib 72 and the position on the discharge port 66's side of the second end portion 722 in terms of a projection perpendicular 92 to the rotational axis of the casing 65.

From the above, since, with the second slanted rib 72, the second end portion 722 of the second slanted rib 72 is located more on the discharge port 66's side than the first end portion 711 of the first slanted rib 71, it is possible to flow most of the toner that is caused to flow along the side 720 on the discharge port 66's side of its own to the side 710 on the discharge port 66's side of the first slanted rib 71.

The above explanations of the embodiments are nothing more than illustrative in any respect, nor should be thought of as restrictive. Scope of the present invention is indicated by claims rather than the above embodiments. Further, it is intended that all changes that are equivalent to a claim in the sense and realm of the doctrine of equivalence be included within the scope of the present invention.

What is claimed is:

1. A toner cartridge that is configured so as to be removably attached to a developing unit and replenishes thereby toner to the developing unit, the cartridge comprising:
a cylindrical casing that is configured so as to be rotatable and is provided with a discharge port for discharging the toner received from a toner inputting side; and
a plurality of slanted ribs provided on an inner circumferential surface of the casing for transporting the toner, with one or more discontinuous sections being formed in between, wherein
each of the plurality of slanted ribs includes a first slanted rib located on a downstream side of the discontinuous section and a second slanted rib located on an upstream side of the discontinuous section with respect to a toner flow direction; and
a first end portion formed on the discontinuous section's side of the first slanted rib is disposed at a position relatively shifted toward the toner inputting side in relation to a second end portion formed on the discontinuous section's side of the second slanted rib.

2. The toner cartridge as claimed in claim 1, wherein the first end portion is disposed at a position shifted toward the toner inputting side in relation to a position on an extension line of the second slanted rib.

3. The toner cartridge as claimed in claim 1, wherein the first end portion is disposed at a position shifted toward the toner inputting side in relation to a position of the second end portion in terms of a projection perpendicular to a rotational axis of the casing.

4. The toner cartridge as claimed in claim 1, wherein the first end portion is bent toward the toner inputting side.

5. The toner cartridge as claimed in claim 1, wherein the second end portion is bent toward the discharge port's side.

6. The toner cartridge as claimed in claim 1, wherein the first end portion has a narrower width of rib than that of the second end portion.

7. An image forming apparatus comprising:
a photoreceptor on which an electrostatic latent image is formed;
a developing unit configured so that thereto the toner cartridge as claimed in claim 1 is removably attached, the developing unit forming a toner image by supplying the photoreceptor with the toner; and
a transfer unit that transfers the toner image directly or indirectly onto a paper sheet and fixes thereon the toner image.
